(19) United States
(12) Patent Application Publication
(10) Pub. No.: US 2019/0041801 A1
(43) Pub. Date: Feb. 7, 2019

(54) Double-Layered Watch Case

(71) Applicant: Shenzhen Singems Timepieces & Jewellery Co.,Ltd., Shenzhen (CN)

(72) Inventor: Ming Da Liang, Shenzhen (CN)

(21) Appl. No.: 15/833,537

(22) Filed: Dec. 6, 2017

(30) Foreign Application Priority Data
Aug. 7, 2017 (CN) 201720975870.X

(51) Int. Cl. G04B 37/22; G04B 37/08

(52) U.S. Cl. CPC G04B 37/22; G04B 37/08

(57) ABSTRACT

The invention relates to the technical field of clocks and watches and discloses a double-layered watch case, comprising an inner cover, an outer cover and two case lugs. Two symmetric sunken embedded portions are provided on the edge of the external bottom of the inner cover. The outer cover is arranged on the external surface of the inner cover in a sleeved and wrapped manner and provided with embedded slots corresponding to the locations of the embedded portions. The case lugs are provided with first connecting portions matching the embedded portions and connected to the embedded portions via the first connecting portions in a detachable manner to fit with the inner cover. In this way, the present invention not only may raise the hardness of the watch case but also has desirable water tightness and may be used in automatic production to save production cost and labor cost.

### TECHNICAL FIELD

The present invention relates to the technical field of clocks and watches, particularly to a double-layered watch case.

### DESCRIPTION OF THE BACKGROUND

The clocks and watches in the prior art generally adopt single-layered watch cases, while following the pursuit to the quality of watches and clocks, certainly people expect the external surface of watch cases has high hardness and is resistant to scratch. The current single-layered watch cases have to be made of a hard and anti-scratch material in an integrated manner. This will result in increase of material cost of processing and manufacturing.

To sum up, the prior art has obvious inconvenience and defect in practice and needs to be improved.

### SUMMARY OF THE INVENTION

To address the foregoing defect, the object of the present invention is to provide a double-layered watch case, which not only may raise the hardness of the watch case but also has desirable water tightness and may be used in automatic production to save production cost and labor cost.

In order to realize the foregoing object, the present invention provides a double-layered watch case, comprising an inner cover, an outer cover and two case lugs, two symmetric sunken embedded portions are provided on the edge of the external bottom of the inner cover, the outer cover is arranged on the external surface of the inner cover in a sleeved and wrapped manner and provided with embedded slots corresponding to the locations of the embedded portions, and the case lugs are provided with first connecting portions matching the embedded portions and connected to the embedded portions via the first connecting portions in a detachable manner to fit with the inner cover.

According to the double-layered watch case described in the present invention, the inner cover and the outer cover match each other in shape and are both in a shape of disc with a hollow-out middle part.

According to the double-layered watch case described in the present invention, the inner cover and/or the outer cover are made integrally by means of punching and/or oil pressing.

According to the double-layered watch case described in the present invention, the two embedded portions correspond to the internal bulges of the inner cover to form two placing portions for receiving watch case components.

According to the double-layered watch case described in the present invention, the embedded portions are connected to the first connecting portions in a threaded manner.

According to the double-layered watch case described in the present invention, each of the embedded portions is provided with at least one first screw hole that is through, the first connecting portions are provided with second screw holes that correspond to the first screw holes and are not through, and bolts are screwed through the first screw holes into the second screw holes to connect and fix the embedded portions and the first connecting portions.

According to the double-layered watch case described in the present invention, each of the case lugs is provided with a second connecting portion connected to a watchband module in a detachable manner, and is connected to the inner cover and fixed with the outer cover via the second connecting portion.

According to the double-layered watch case described in the present invention, a button installing hole is provided on the exterior wall of the inner cover, and the outer cover is provided with an installing hole matching the button installing hole.

According to the double-layered watch case described in the present invention, the inner cover and the outer cover are made of different materials.

The double-layered watch case described in the present invention comprises an inner cover, an outer cover and two case lugs, two symmetric sunken embedded portions are provided on the edge of the external bottom of the inner cover, the outer cover is arranged on the external surface of the inner cover in a sleeved and wrapped manner and provided with embedded slots corresponding to the locations of the embedded portions, and the case lugs are provided with first connecting portions matching the embedded portions and connected to the embedded portions via the first connecting portions in a detachable manner to fit with the inner cover. In this way, the present invention not only may raise the hardness of the watch case but also has desirable water tightness and may be used in automatic production to save production cost and labor cost.

### BRIEF DESCRIPTION OF THE DRAWINGS

FIG. 1 is a front structural schematic view of the double-layered watch case in a preferred embodiment of the present invention.

FIG. 2 is a back structural schematic view of the double-layered watch case in a preferred embodiment of the present invention.

FIG. 3 is a top structural schematic view of the inner cover in a preferred embodiment of the present invention.

FIG. 4 is a front structural schematic view of the inner cover in a preferred embodiment of the present invention.

FIG. 5 is a right structural schematic view of the inner cover in a preferred embodiment of the present invention.

FIG. 6 is a top structural schematic view of the outer cover in a preferred embodiment of the present invention.

FIG. 7 is a front structural schematic view of the outer cover in a preferred embodiment of the present invention.

FIG. 8 is a structural sectional view of the outer cover connected to the inner cover in a sleeved manner in a preferred embodiment of the present invention.

FIG. 9 is a front structural schematic view of the case lug in a preferred embodiment of the present invention.

FIG. 10 is a back structural schematic view of the case lug in a preferred embodiment of the present invention.

### DETAILED DESCRIPTION OF PREFERRED EMBODIMENTS

The present invention will now be described by referring to the accompanying drawings and embodiments, from which its objects, technical schemes and advantages will be evident. It should be understood that the preferred embodiments described here are intended to illustrate and not to limit the present invention.

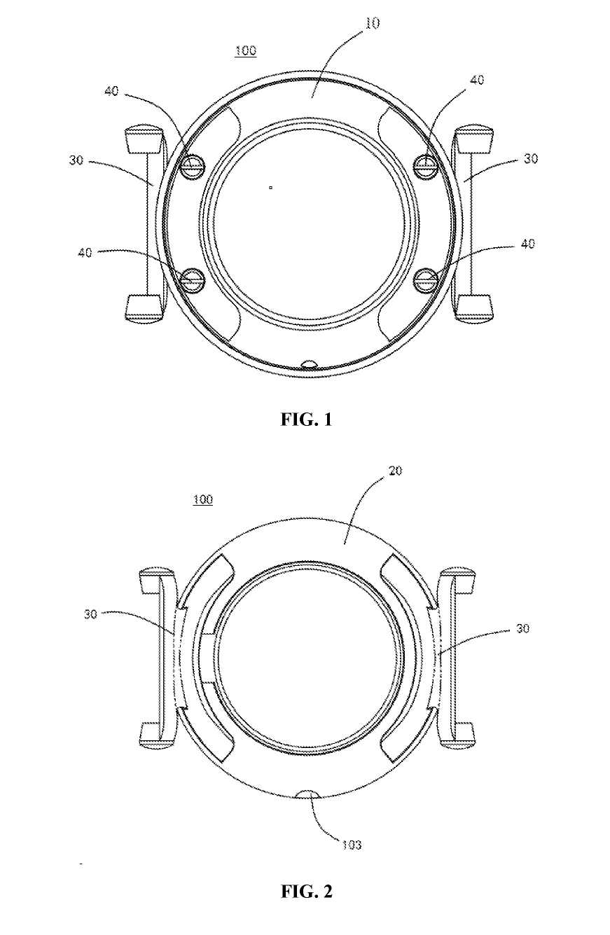

FIG. 1-FIG. 2 show the double-layered watch case 100 in a preferred embodiment of the present invention, comprising an inner cover 10, an outer cover 20 and two case lugs 30. Two symmetric sunken embedded portions 101 are provided on the edge of the external bottom of the inner cover 10, as shown in FIG. 4. The outer cover 20 is arranged on the external surface of the inner cover 10 in a sleeved and wrapped manner and provided with embedded slots 201 corresponding to the locations of the embedded portions 101, as shown in FIG. 6. The case lugs 30 are provided with first connecting portions 301 matching the embedded portions 101 and connected to the embedded portions 101 via the first connecting portions 301 in a detachable manner to fit with the inner cover 10. The double-layered structure is even harder, and the outer cover may play a buffering role and provide better water tightness. As clocks and watches attach more importance to the hardness and scratch resistance of external surface, it is preferred in the present invention that the inner cover 10 and the outer cover 20 are made of different materials. To be specific, the outer cover 20 is made of a material with higher hardness and better anti-scratch performance and the inner cover 10 is made of an ordinary material. The outer cover 20 may be much thinner than the watch cases in the prior art, so it may save material cost in the manufacturing process. Further, the inner cover 10 and the outer cover 20 have a simple structure, making for integral forming and processing.

The inner cover 10 and/or the outer cover 20 are made integrally by means of punching and/or oil pressing. Preferably, the inner cover 10 and the outer cover 20 are made of thin sheets integrally by means of punching and/or oil pressing. As the structures are simple, they may be automatically produced separately to raise processing efficiency, facilitate mass production and save production cost and labor cost.

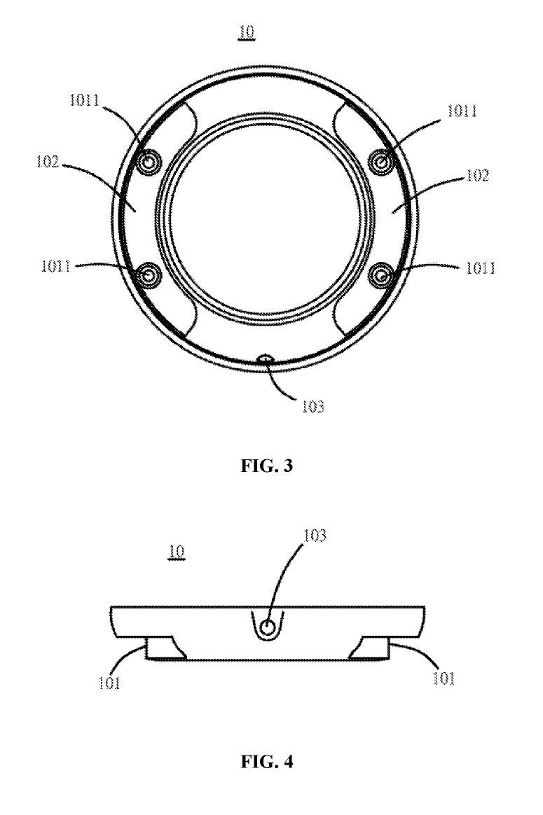

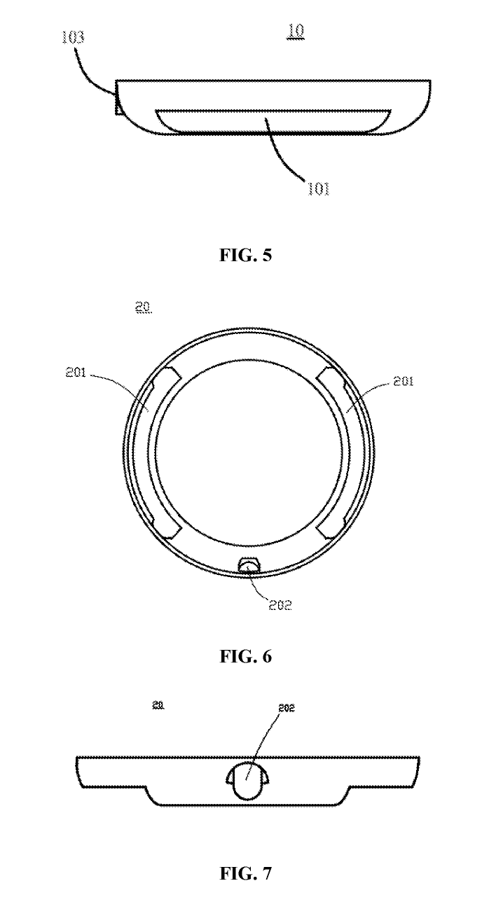

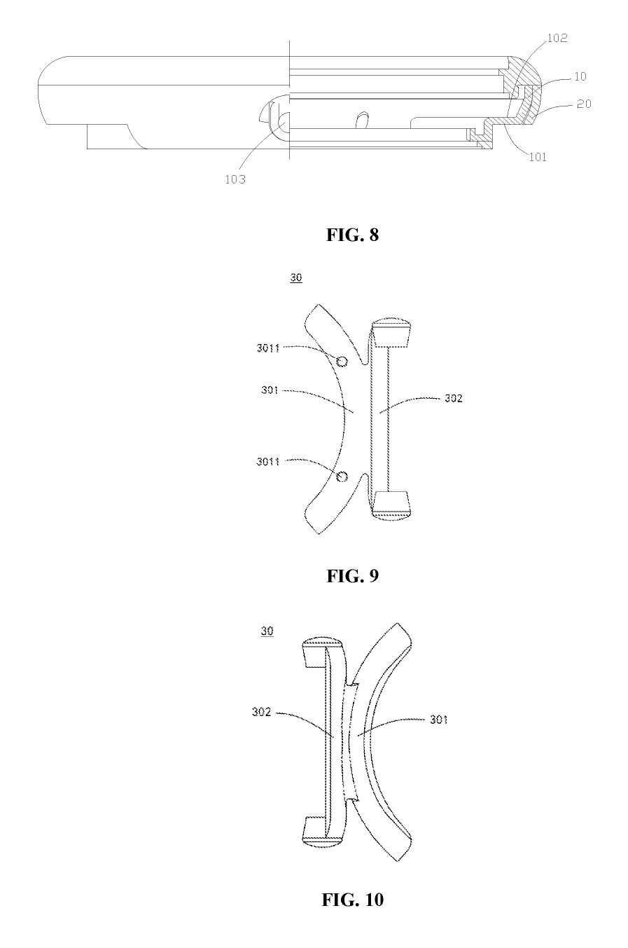

As shown in FIG. 3-FIG. 8, the inner cover 10 and the outer cover 20 match each other in shape. It is preferred in this embodiment that the inner cover 10 and the outer cover 20 are both in a shape of disc with a hollow-out middle part. Of course, they may also be in a polygonal shape with a hollow-out middle part, such as rectangle and polynedron. The diameter of the outer cover 20 is slightly greater than the diameter of the inner cover 10 so that the inner cover 10 can be received in and fit well with the outer cover 20. The embedded portions 101 match the embedded slots 201 in a one-to-one manner. Further, the two embedded portions 101 are symmetrically arranged on the two sides of the inner cover 10 and in an arc shape, and the case lugs 30 and the matched first connecting portions 301 are against and fit with the embedded portions 101.

To be specific, the two embedded portions 101 correspond to the internal bulges of the inner cover 10 to form two placing portions 102 for receiving watch case components. The two placing portions 102 are arranged symmetrically on the inner edge of the inner cover 10, have a same height and are both lower than the upper edge of the inner cover 10.

Preferably, the embedded portions 101 are connected to the first connecting portions 301 in a threaded manner. Of course, other connecting manners are also allowed. Each of the embedded portions 101 is provided with at least one first screw hole 1101 that is through, the first connecting portions 301 are provided with second screw holes 3011 that correspond to the first screw holes 1101 and are not through, and bolts 40 are screwed through the first screw holes 1101 into the second screw holes 3011 to connect and fix the embedded portions 101 and the first connecting portions 301. In this embodiment, every embedded portion 101 is provided with two symmetric first screw holes 1011, and the first connecting portion 301 of every case lug 30 is provided with two second screw holes 3011 corresponding to the two first screw holes 1011. As the second screw holes 3011 are not through, the bolts 40 will not stick out of the external bottom surface when the bolts 40 are screwed through the first screw holes 1011 from inside of the inner cover 10 to the second screw holes 3011, and thus it has good water resistance.

Each of the case lugs 30 is further provided with a second connecting portion 302 connected to a watchband module in a detachable manner, connected to the inner cover 10 and fixed with the outer cover 20 via the second connecting portion 302. The second connecting portion 302 outwardly connects the watchband.

A button installing hole 103 is provided on the exterior wall of the inner cover 10, and the outer cover 20 is provided with an installing hole 202 matching the button installing hole 103. The button installing hole 103 applies the function of knob installation or button installation.

To sum up, the double-layered watch case described in the present invention comprises an inner cover, an outer cover and two case lugs. Two symmetric sunken embedded portions are provided on the edge of the external bottom of the inner cover. The outer cover is arranged on the external surface of the inner cover in a sleeved and wrapped manner and provided with embedded slots corresponding to the locations of the embedded portions. The case lugs are provided with first connecting portions matching the embedded portions and connected to the embedded portions via the first connecting portions in a detachable manner to fit with the inner cover. In this way, the present invention can raise the hardness of the watch case and also has desirable water resistance and may be used in automatic production to save production cost and labor cost.

Of course, the present invention may also have other various embodiments. Those skilled in the art may make various changes and modifications to the present invention without departing from the spirit and essence of the present invention, but these changes and modifications all shall be within the protection scope of claims of the present invention.

1. A double-layered watch case comprising an inner cover, an outer cover and two case lugs; two symmetric sunken embedded portions being provided on the edge of the external bottom of the inner cover; the outer cover being arranged on the external surface of the inner cover in a sleeved and wrapped manner and provided with embedded slots corresponding to the locations of the embedded portions; the case lugs being provided with first connecting portions matching the embedded portions and connected to the embedded portions via the first connecting portions in a detachable manner to fit with the inner cover.

2. The double-layered watch case according to claim 1, wherein the inner cover and the outer cover match each other in shape and are both in a shape of disc with a hollow-out middle part.

3. The double-layered watch case according to claim 1, wherein the inner cover and/or the outer cover are made integrally by means of punching and/or oil pressing.

4. The double-layered watch case according to claim 1, wherein the two embedded portions correspond to the internal bulges of the inner cover to form two placing portions for receiving watch case components.

5. The double-layered watch case according to claim 1, wherein the embedded portions are connected to the first connecting portions in a threaded manner.

6. The double-layered watch case according to claim 5, wherein each of the embedded portions is provided with at least one first screw hole that is through; the first connecting portions being provided with second screw holes that correspond to the first screw holes and are not through; and bolts being screwed through the first screw holes into the second screw holes to connect and fix the embedded portions and the first connecting portions.

7. The double-layered watch case according to claim 1, wherein each of the case lugs is further provided with a second connecting portion connected to a watchband module in a detachable manner and is connected to the inner cover and fixed with the outer cover via the second connecting portion.

8. The double-layered watch case according to claim 1, wherein a button installing hole is provided on the exterior wall of the inner cover; and the outer cover being provided with an installing hole matching the button installing hole.

9. The double-layered watch case according to claim 1, wherein the inner cover and the outer cover are made of different materials.
